(19) United States
(12) Patent Application Publication
(10) Pub. No.: US 2009/0218972 A1
(43) Pub. Date: Sep. 3, 2009

(54) METHOD AND APPARATUS FOR DETECTING REVERSE CURRENT, AND METHOD AND APPARATUS FOR DRIVING MOTOR

(76) Inventors: Yasunori YAMAMOTO, Osaka (JP); Hisanori Nagase, Osaka (JP); Hideaki Mori, Hyogo (JP)

Correspondence Address: MCDERMOTT WILL & EMERY LLP, 600 13TH STREET, NW, WASHINGTON, DC, 20005-3096, US

(21) Appl. No.: 12/389,832

(22) Filed: Feb. 20, 2009

(30) Foreign Application Priority Data
Mar. 3, 2008 (JP) 2008-051940

(51) Int. Cl. H02P 6/14

(52) U.S. Cl. 318/400.28; 318/400.09

(57) ABSTRACT

A reverse current detection apparatus determines whether an electrical conduction control to a motor coil of a motor is in a predetermined state based on a timing signal representing a timing at which to conduct a source current or a sink current through the motor coil and a control signal for a half bridge in a power stage, and compares the output voltage of the power stage with a threshold value, so as to detect the presence/absence of a reverse flow of a phase current based on these results. A motor driving apparatus for driving a motor under a PWM control includes a rectification switching section for switching a rectification scheme from one to another based on the reverse current detection apparatus and a detection result thereof.

### CROSS REFERENCE TO RELATED APPLICATION

This application claims priority under 35 U.S.C. §119 on Patent Application No. 2008-51940 filed in Japan on Mar. 3, 2008, the entire contents of which are hereby incorporated by reference.

### BACKGROUND OF THE INVENTION

The present disclosure relates to a method for driving a motor. More particularly, the present disclosure relates to detecting a reverse flow of a phase current through a PWM-driven motor, and to switching rectification schemes from one to another based on the detection.

The pulse width modulation (PWM) of a synchronous rectification scheme has been widely used in the art as a motor driving method capable of reducing the power consumption. The synchronous rectification driving method has design restrictions in that some dead time needs to be provided so that at no time is there a through current caused by two transistors connected in series between the higher power supply and the lower power supply which are ON at the same time. Nevertheless, if these transistors have a low ON voltage, a further reduction in the power consumption can be made by synchronous rectification. Moreover, by a PWM with smooth duty cycle variations such as sinusoidal modulation, it is possible to obtain an ideal phase current waveform and to thereby reduce vibration and noise of the motor.

When there is a rapid decrease of the torque command to the motor or a torque variation in a pull-in operation toward a certain rotational speed, if the recirculation direction of the phase current is reversed by the generated voltage during synchronous rectification, the phase current may be regenerated in the following energization period to increase the power supply voltage. This may cause the withstand voltage breakdown of the system, requiring a large withstand voltage margin against such a breakdown, thus resulting in a cost increase.

Approaches to the problems above include: (1) to identify a deceleration command based on a change in the torque command and stop the synchronous rectification during the deceleration period; (2) to turn ON the lower power supply-side transistor if the voltage at the output terminal of the motor driving apparatus is greater than or equal to the power supply voltage and turn ON the higher power supply-side transistor if the voltage is less than or equal to the ground voltage to thereby forcibly bring the phase, of which the reverse current flow has been detected, back to the energized state; and (3) to provide a motor driving apparatus that turns ON an output-stage transistor in synchronism with a predetermined pulse and turns OFF the output-stage transistor when the motor current detected by the shunt resistor reaches the torque command, wherein the synchronous rectification is stopped when detecting the reverse flow of a phase current based on the polarity of the ON voltage of the transistor.

### SUMMARY OF THE INVENTION

With the approach (1), it is not guaranteed that the period of the deceleration command as determined based on a change in the torque command precisely coincides with the period in which the regeneration of the phase current actually occurs. Moreover, the deceleration detection means may not function effectively with regeneration occurring during a motor current pull-in operation. Therefore, if the response of the deceleration detection means is slow, it may be possible that the phase current regeneration cannot be suppressed, thereby leading to an increase in the power supply voltage and thus to a device breakdown. If the response of the deceleration detection means is made sensitive in order to prevent the breakdown, it may be possible that the synchronous rectification is stopped even during a period in which there is no increase in the power supply voltage, thus sacrificing the low vibration characteristics and the low noise characteristics.

With the approach (2), if a phase current flow is reversed and the voltage at the output terminal decreases below the ground voltage during a recirculation period in which the lower power supply-side transistors of two phases are ON, a high potential-side transistor of one phase is turned ON to thereby cause strong plug braking. This does not match with the torque command, and therefore increases the power consumption and delays the pull-in operation toward a certain rotational speed. Thus, the approach (2) is not suitable for the synchronous rectification driving method.

The approach (3) is an attempt to suppress the regeneration of a phase current in a motor driving apparatus in which the phase delay of a current is eliminated by performing a PWM control based on the motor current detected by a shunt resistor, and it cannot easily be applied to an ordinary motor driving apparatus in which the current phase is lagged behind the voltage phase. Moreover, if the ON voltage of a transistor is low, the reverse flow of a phase current may be detected falsely due to noise, or the like, and the synchronous rectification may be stopped frequently, thus sacrificing the low vibration characteristics and the low noise characteristics.

In view of these problems, the presently disclosed device may be advantageous for the detection of a reverse flow of a phase current that is suitable for a PWM motor driving operation based on a synchronous rectification scheme. Moreover, the presently disclosed device may be advantageous in that it is possible, by utilizing such a reverse current detection method, to realize a motor driving method capable of suppressing the regeneration of a phase current while maintaining the low vibration characteristics and the low noise characteristics.

An example method is a method for detecting a reverse flow of a phase current supplied to a motor coil from a node between a higher power supply-side transistor and a lower power supply-side transistor, which are connected in series with each other to form a half bridge, by driving the half bridge under a PWM control, the method including the steps of: determining whether an electrical conduction control to the motor coil is in a predetermined state based on a timing signal representing a timing at which to conduct a source current or a sink current through the motor coil and a control signal for the half bridge; comparing a voltage at the node with a threshold value; determining whether the voltage at the node is shifted from an ideal value in the predetermined state based on a result of the comparison; and determining that the phase current is reversed if it is determined that the electrical conduction control to the motor coil is in the predetermined state and if it is determined that the voltage at the node is shifted from the ideal value. An example embodiment corresponding to this method is a reverse current detection apparatus, including: a state determination section for receiving a timing signal representing a timing at which to conduct a source current or a sink current through the motor coil and a control signal for the half bridge, and for determining whether an electrical conduction control to the motor coil is in a predetermined state based on the received signals; a comparator for comparing a voltage at the node with a threshold value; and a reverse current determination section for determining whether the phase current is reversed based on a determination result of the state determination section and a comparison result of the comparator.

Another example method is a method for driving a motor under a PWM control, including: a first step of detecting a reverse flow of a phase current supplied to at least one motor coil of the motor according to the reverse current detection method set forth above; and a second step of switching a rectification scheme of the PWM control of the motor from synchronous rectification to non-synchronous rectification when the reverse flow of a phase current is detected. An example apparatus is a motor driving apparatus corresponding to this method, including: the reverse current detection apparatus set forth above; and a rectification switching section for switching between synchronous rectification and non-synchronous rectification as a rectification scheme of the motor driving apparatus based on a detection result of the reverse current detection apparatus.

Particular embodiments provide the following advantages: the reverse flow of a phase current is detected based on various signals for the electrical conduction control to a motor coil and the voltage on the motor coil, whereby it is possible to realize a reliable phase current reverse flow detection for use in a PWM motor driving operation based on a synchronous rectification scheme. Moreover, by applying such a reliable phase current reverse flow detection to a PWM motor driving operation, it is possible to effectively avoid an increase in the power supply voltage by switching to non-synchronous rectification only when the phase current flow is really reversed while using synchronous rectification during normal operation to maintain the low vibration characteristics and the low noise characteristics.

### BRIEF DESCRIPTION OF THE DRAWINGS

FIG. 1 is a diagram showing a configuration of a motor driving apparatus according to an example embodiment.

FIGS. 2A to 2F are timing diagrams showing the relationship between the voltage profile to be applied to a motor and the timing signal output from a commutation control section.

FIGS. 3A and 3B are diagrams each showing the direction of a phase current when energized by the source current.

FIGS. 4A and 4B are diagrams each showing the direction of a phase current when energized by the sink current.

FIG. 5 is a diagram showing a configuration of a reverse current detection apparatus and a peripheral circuit thereof.

FIG. 6 is a diagram showing a configuration of a reverse current detection apparatus for monitoring all phases and a peripheral circuit thereof.

FIG. 7 is a diagram showing a configuration of a reverse current detection apparatus with a reduced number of slicers and comparators and a peripheral circuit thereof.

FIGS. 8A to 8F are timing diagrams showing the relationship between the control signal for the higher power supply-side transistor and the lower power supply-side transistor where there is a clamp circuit and the power stage output voltage.

FIGS. 9A to 9C are timing diagrams also showing the relationship between the control signal for the higher power supply-side transistor and the power stage output voltage where there is a clamp circuit.

FIG. 10 is a diagram showing a configuration of a reverse current detection apparatus and a peripheral circuit thereof where there is a clamp circuit.

FIG. 11 is a diagram showing a configuration of a reverse current detection apparatus for monitoring all phases and a peripheral circuit thereof where there is a clamp circuit.

FIG. 12 is a diagram showing a configuration of a reverse current detection apparatus with a reduced number of slicers and comparators and a peripheral circuit thereof where there is a clamp circuit.

FIG. 13 is a timing diagram showing an example of how to control the higher power supply-side transistor and the lower power supply-side transistor of each phase under non-synchronous rectification.

FIG. 14 is a timing diagram showing an example of how rectification schemes are switched from one to another by a rectification switching section.

### DETAILED DESCRIPTION OF THE INVENTION

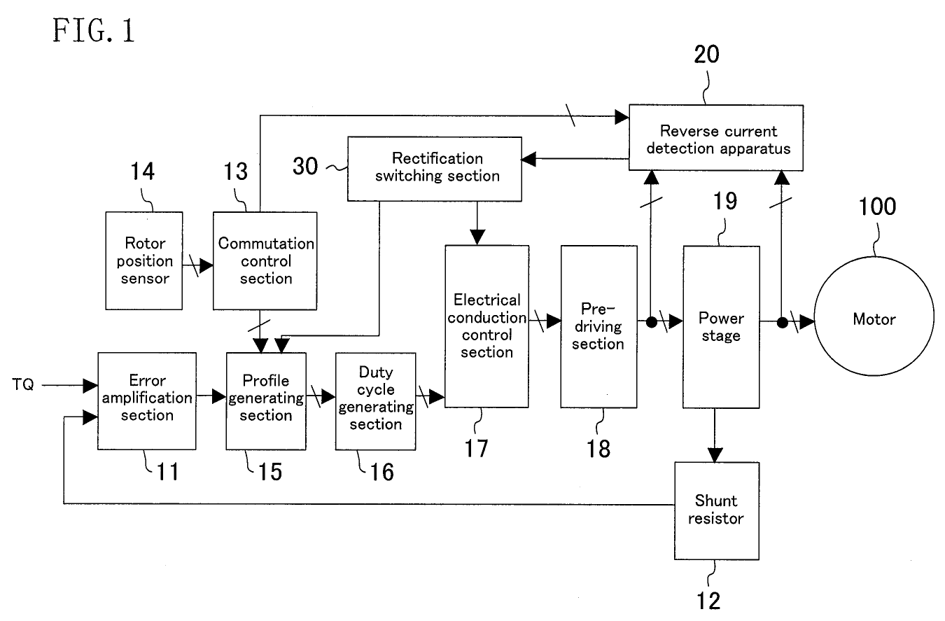

A preferred embodiment of the present invention will now be described with reference to the drawings. FIG. 1 shows a configuration of a motor driving apparatus according to an example embodiment. An error amplification section 11 amplifies the error between the torque command TQ and the voltage of a shunt resistor 12. A commutation control section 13 generates cycle information and phase information based on the output of a rotor position sensor 14. A profile generating section 15 generates a plurality of phases of voltage profiles each as an average voltage waveform to be applied to a motor 100, based on the amplified error signal, the cycle information and the phase information. A duty cycle generating section 16 generates a PWM signal based on a voltage profile. An electrical conduction control section 17 drives a pre-driving section 18 according to the PWM signal. The pre-driving section 18 performs a level conversion on the PWM signal and controls the switching of a transistor (not shown) in a power stage 19 to thereby drive the motor 100. A reverse current detection apparatus 20 determines whether the phase current flow is reversed in the motor 100 based on the outputs of the pre-driving section 18, the power stage 19 and the commutation control section 13. A rectification switching section 30 controls the profile generating section 15 and the electrical conduction control section 17 based on the determination result of the reverse current detection apparatus 20.

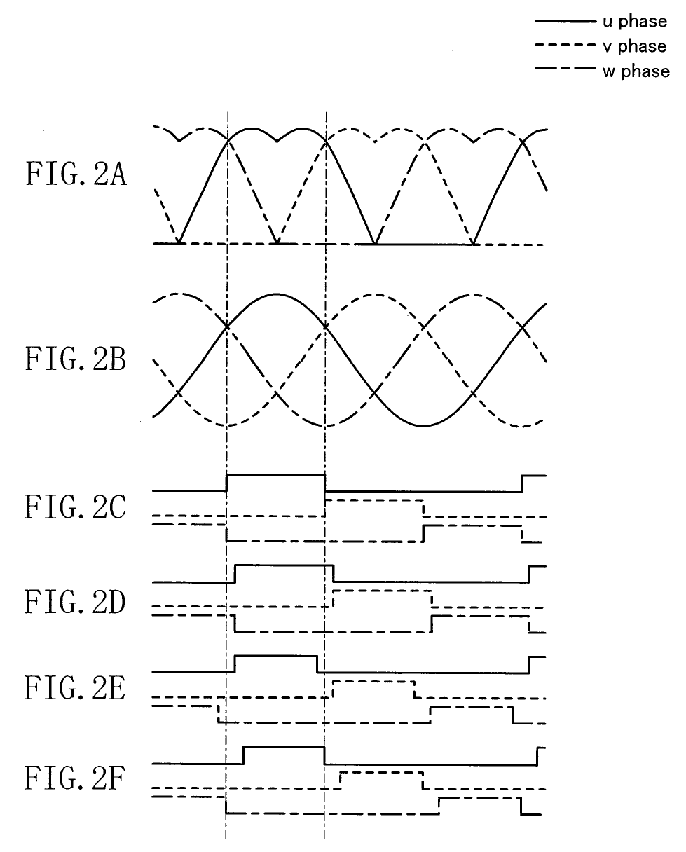

FIGS. 2A to 2F show the relationship between the voltage profile to be applied to the motor 100 and the timing signal output from the commutation control section 13 to the reverse current detection apparatus 20. For discussion purposes, the motor 100 is herein assumed to be a three-phase motor. FIGS. 2A and 2B each show voltage profiles of the U phase, the V phase and the W phase of the motor 100 in two-phase modulation and three-phase modulation, respectively. Two-phase modulation is similar to three-phase modulation, wherein a phase of the lowest potential at any point in time is fixed to zero potential. Therefore, they are equivalent to each other, but two-phase modulation has a reduced number of modulated phases, and two-phase modulation can use a higher maximum torque.

FIG. 2C is a timing diagram obtained by setting, to the H level, the maximum duty period of each phase in two-phase modulation or three-phase modulation. Thus, in a three-phase motor driving method, the phase to be in the source current mode in the power stage 19 is switched from one to another for every 120 electrical degrees. The commutation control section 13 gives an output to the reverse current detection apparatus 20 using a signal as shown in the timing diagram of FIG. 2C as the timing signal. Since the current phase is typically lagged behind the voltage phase, each phase of the timing signal may be slightly delayed as shown in the timing diagram of FIG. 2D. The amount by which the phase is delayed may be determined based on the rotational speed of the motor 100 or on the motor coil constant. Alternatively, each phase of the timing signal may stay at the H level over shorter periods than 120 electrical degrees, as shown in FIG. 2E. Alternatively, each phase of the timing signal may be slightly delayed while staying at the H level over shorter periods than 120 electrical degrees, as shown in FIG. 2F. In any case, these various timing signals can be generated freely based on the output of the rotor position sensor 14.

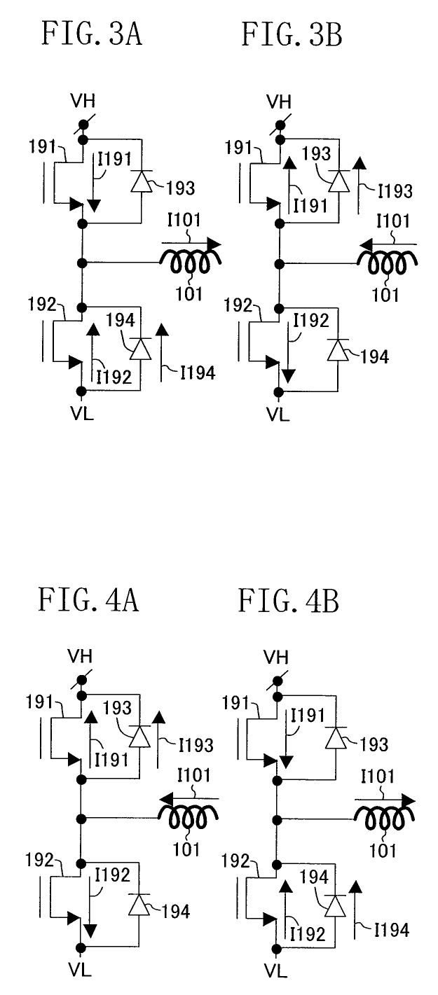

Next, the detection of the reversal of the phase current flow will be described. FIGS. 3A and 3B each show the direction of a phase current when energized by the source current. In these figures, the half bridge formed by a higher power supply-side transistor 191 and a lower power supply-side transistor 192 is a half bridge for one of the U phase, the V phase and the W phase in the power stage 19. The node between the transistor 191 and the transistor 192 is the output terminal of that phase, and a motor coil 101 of the motor 100 is connected to the node. Free wheeling diodes 193 and 194 are connected in parallel to the transistors 191 and 192, respectively.

The higher power supply potential is denoted as VH, the lower power supply potential as VL, and the forward voltage drop of the free wheeling diodes 193 and 194 as Vd. The currents flowing through the motor coil 101, the transistors 191 and 192, and the free wheeling diodes 193 and 194 are denoted as I101, I191, I192, I193 and I194, respectively. For discussion purposes, it is assumed that the ON voltages of the transistors 191 and 192 are both Von.

In FIG. 3A, only the transistor 191 is ON during the energization period, and the transistor current I191 flows as the phase current I101. The output voltage of this phase in the power stage 19 is VH−Von. During the diode recirculation period being a high impedance period (hereinafter referred to as the HZ period) for preventing a through current after the energization period, the transistors 191 and 192 are both OFF and the diode current I194 flows as the phase current I101. The output voltage in this period is VL−Vd. During the next synchronous rectification recirculation period, only the transistor 192 is ON, and the transistor current I192 flows as the phase current I101. The output voltage in this period is VL−Von.

If the ON state of the transistor 192 continues for a long time due to a rapid decrease of the torque command, or the like, the phase current I101 is reversed due to the back-electromotive force of the motor coil 101, whereby the transistor current I192 flows in the direction toward the lower power supply (see FIG. 3B). The output voltage in this period is VL+Von. During the following diode recirculation period, the transistors 191 and 192 are both OFF, and the diode current I193 flows in the direction toward the higher power supply as the phase current I101, thus leading to an increase in the power supply voltage. The output voltage in this period is VH+Vd. The following period is supposed to be an energization period in which only the transistor 191 is ON. However, the transistor current I191 flows in the direction toward the higher power supply as the phase current I101, thus leading to an increase in the power supply voltage. The output voltage in this period is VH+Von. Since the higher power supply does not have a sink capability, the current in-flow directly results in a voltage increase, thereby increasing the VH value itself.

Based on the above, the reverse flow of a phase current can be detected by the following three methods.

(1) When only the transistor 191 is ON, the output voltage of the power stage 19 is compared with a threshold value within the range of VH±Von, and it is determined that the phase current is reversed if the former is greater.

(2) When the transistors 191 and 192 are both OFF, the output voltage of the power stage 19 is compared with a threshold within the range of VL−Vd to VH+Vd, and it is determined that the phase current is reversed if the former is greater.

(3) When only the transistor 192 is ON, the output voltage of the power stage 19 is compared with a threshold value within the range of VL±Von, and it is determined that the phase current is reversed if the former is greater.

Reverse current detection methods as described above can also be used when the motor coil is energized by the sink current. FIGS. 4A and 4B each show the direction of a phase current when energized by the sink current. In FIG. 4A, only the transistor 192 is ON during the energization period, and the transistor current I192 flows as the phase current I101. The output voltage of this phase in the power stage 19 is VL+Von. During the next diode recirculation period, the transistors 191 and 192 are both OFF and the diode current I193 flows as the phase current I101. The output voltage in this period is VH+Vd. During the next synchronous rectification recirculation period, only the transistor 191 is ON, and the transistor current I191 flows as the phase current I101. The output voltage in this period is VH+Von. The transistor current I191 and the diode current I193 are recirculating in the natural direction, and do not contribute to the increase in the power supply voltage.

If the ON state of the transistor 191 continues for a long time due to a rapid decrease of the torque command, or the like, the phase current I101 is reversed due to the back-electromotive force of the motor coil 101, and the transistor current I191 flows in the direction toward the node (see FIG. 4B). The output voltage in this period is VH−Von. During the following diode recirculation period, the transistors 191 and 192 are both OFF, and the diode current I194 flows in the direction toward the node as the phase current I101. This current flows through the higher power supply-side transistors in multiple phases of half bridges (not shown) to the higher power supply, thus increasing the power supply voltage. The output voltage in this period is VL−Vd. The following period is supposed to be an energization period in which only the transistor 192 is ON. However, the transistor current I192 flows in the direction toward the node as the phase current I101, thus leading to an increase in the power supply voltage. The output voltage in this period is VL−Von.

Based on the above, the reverse flow of a phase current can be detected by the following three methods in a case where the motor coil is energized by the sink current.

(1′) Where only the transistor 192 is ON, the output voltage of the power stage 19 is compared with a threshold value within the range of VL±Von, and it is determined that the phase current is reversed if the former is smaller.

(2′) Where the transistors 191 and 192 are both OFF, the output voltage of the power stage 19 is compared with a threshold value within the range of VL−Vd to VH+Vd, and it is determined that the phase current is reversed if the former is smaller.

(3′) Where only the transistor 191 is ON, the output voltage of the power stage 19 is compared with a threshold value within the range of VL±Von, and it is determined that the phase current is reversed if the former is smaller.

The ON voltage of the transistors 191 and 192 is typically set to be smaller than the forward voltage drop (about 0.8 V) of the free wheeling diodes 193 and 194. For example, it is set to be about 0.4 V. Therefore, of the six detection methods described above, the range of the threshold value is narrow with the methods (1), (3), (1′) and (3′), and wide with the methods (2) and (2′). Particularly, the methods (2) and (2′) are advantageous in cases where the ON voltage of the transistor in the power stage 19 is low.

In two-phase modulation shown in FIG. 2A, the lower power supply-side transistor of a non-modulated phase is fixed to the ON state. The phase being at the H level in the timing diagram shown in FIGS. 2C to 2F is in the source current mode. Therefore, for a phase for which the timing signal is at the H level, the reverse flow of a phase current can be detected by any of the methods (1) to (3) or a combination thereof. During a period that is shifted from the H level by 180 electrical degrees, each phase is in the sink current mode. Therefore, during this period in which only the lower power supply-side transistor is ON, the reverse flow of a phase current can be detected by the method (1′). In two-phase modulation where the higher power supply-side transistor of a non-modulated phase is fixed to the ON state, the reverse flow of a phase current can be detected by any of the methods (1′) to (3′) or a combination thereof for a phase for which the timing signal is at the H level, and by the method (1) during a period in which the phase is in the source current mode.

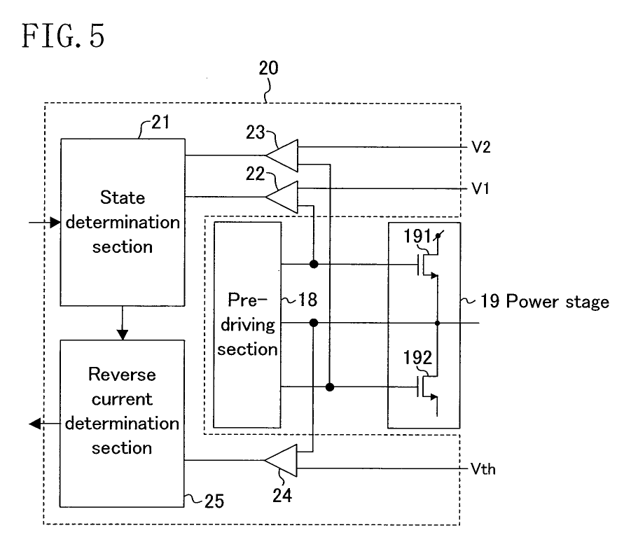

Referring back to FIG. 1, the reverse current detection apparatus 20 detects the reverse flow of a phase current according to a reverse current detection method as described above. Specifically, the reverse current detection apparatus 20 receives the output signal of the pre-driving section 18 and the output signal and the power stage 19, and also receives a timing signal from the commutation control section 13, to output a reverse current detection signal when the reverse flow of a phase current in the motor 100 is detected based on these signals. FIG. 5 shows a configuration of the reverse current detection apparatus 20 and a peripheral circuit thereof. The reverse current detection apparatus 20 detects the reverse flow of a phase current according to the method (2) or (2′) for one phase of the motor 100. In the reverse current detection apparatus 20, a state determination section 21 receives the timing signal and control signals to the higher power supply-side transistor 191 and the lower power supply-side transistor 192 of the power stage 19, and determines based on these signals whether the electrical conduction control to a motor coil that is connected to the node of these transistors is in a predetermined state. The predetermined state is uniquely determined depending on the reverse current detection method. With the method (2), for example, the predetermined state is where it is instructed to conduct a source current through the motor coil and it is instructed to turn OFF the higher power supply-side transistor 191 and the lower power supply-side transistor 192. The predetermined state can be determined through a logic operation on the input signal.

With the transistors 191 and 192 in the power stage 19 having a relatively large input capacitance, the control signal output from the pre-driving section 18 transitions smoothly so as to suppress the radiant noise from the switching of these transistors. In view of this, it is preferred that the control signals to these transistors are digitized by slicers 22 and 23 before being input to the state determination section 21. Threshold values V1 and V2 to be input to the slicers 22 and 23 are each preferably set to a mean level of the possible values of the corresponding control signal.

A comparator 24 compares the voltage at the transistor node with the threshold value Vth. A reverse current determination section 25 determines whether the phase current is flowing in the reverse direction based on the determination result of the state determination section 21 and the comparison result of the comparator 24. The range of the threshold value Vth and the reverse current determination method are as described above. The reverse current determination section 25 outputs the reverse current detection signal when it is determined that the phase current is flowing in the reverse direction.

Where the reverse current detection apparatus 20 uses the method (1) or (3′), there is no need for the slicer 23 and to input a control signal for the lower power supply-side transistor 192 to the state determination section 21. Where the reverse current detection apparatus 20 uses the method (3) or (1′), there is no need for the slicer 22 and to input a control signal for the higher power supply-side transistor 191 to the state determination section 21.

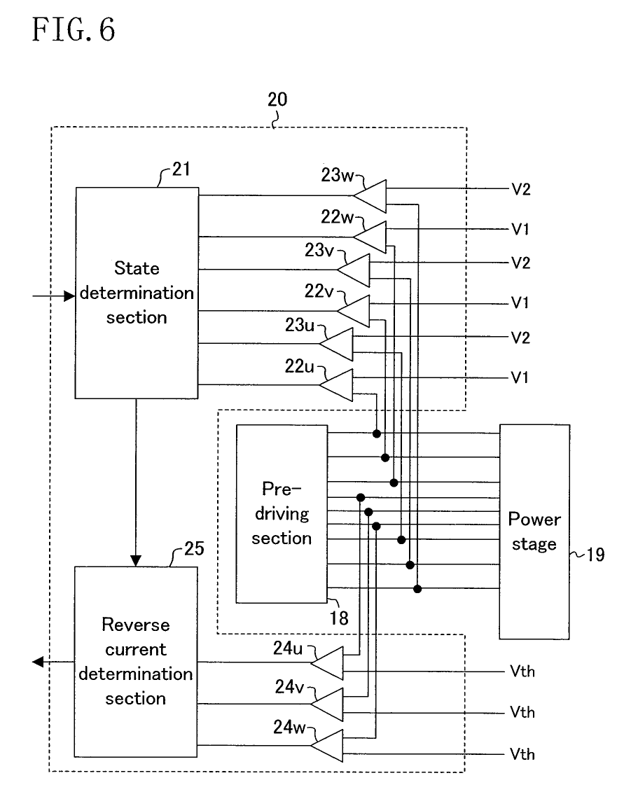

A reverse current detection with a higher precision can be realized by monitoring more than one phase, e.g., all phases, as opposed to monitoring the motor coil of one phase. FIG. 6 shows a configuration of the reverse current detection apparatus 20 for monitoring all phases of the motor 100 and a peripheral circuit thereof. The reverse flow of a phase current can be detected for all phases of the motor 100 by providing slicers 22 (22u, 22v, 22w) and 23 (23u, 23v, 23w) and comparators 24 (24u, 24v, 24w) for each phase.

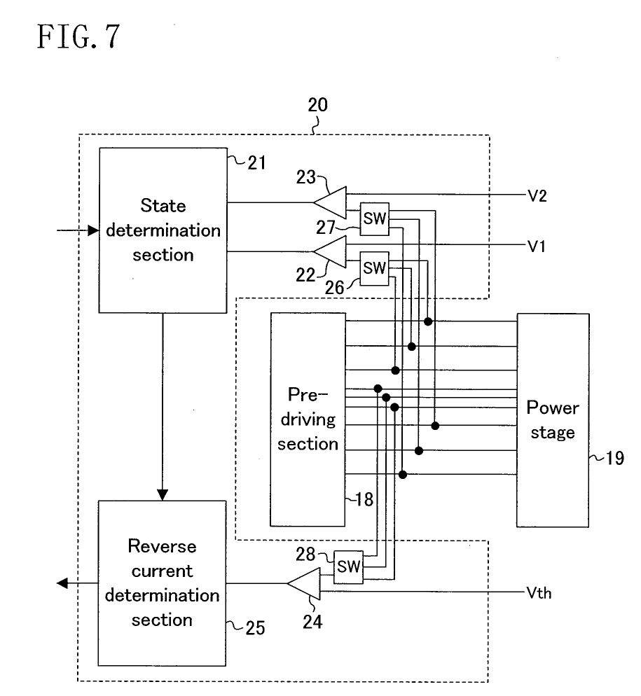

Alternatively, the phase to be monitored can be switched from one to another for every 120 electrical degrees, in which case only one of the slicers 22, one of the slicers 23, and one of the comparators 24. FIG. 7 shows a configuration of the reverse current detection apparatus 20 with a reduced number of slicers and comparators and a peripheral circuit thereof. A switch 26 selects one of the control signals for the higher power supply-side transistors of the U phase, the V phase and the W phase for every 120 electrical degrees. A switch 27 selects one of the control signals for the lower power supply-side transistors of the U phase, the V phase and the W phase for every 120 electrical degrees. A switch 28 selects one of the output voltages of the U phase, the V phase and the W phase for every 120 electrical degrees.

Where the three phases are all monitored, if the period in which the timing signal is at the H level is set to be at least 120 electrical degrees for each phase (e.g., the timing diagram of FIG. 2C), the reverse flow of a phase current can be detected through the entire cycle. If the period is set to be shorter than 120 electrical degrees (e.g., the timing diagrams of FIGS. 2E and 2F), there will be intervals during which the detection cannot be done.

A motor driving apparatus is sometimes provided, for the purpose of preventing the breakdown of the higher power supply-side transistor in the power stage 19, with a clamp circuit for clamping the control voltage for the higher power supply-side transistor so that the control voltage for the higher power supply-side transistor is prevented from becoming higher than the output voltage of the power stage 19 by a predetermined potential difference even if the output voltage of the power stage 19 increases due to an induced voltage while the higher power supply-side transistor is turned OFF. In the presence of such a clamp circuit, the control voltage for the higher power supply-side transistor, which is supposed to be at the L level, is brought to the H level along with the increase in the output voltage of the power stage 19, thereby failing to correctly determine the ON state of the higher power supply-side transistor. Thus, it is difficult to detect the reverse current by the methods (1) and (2).

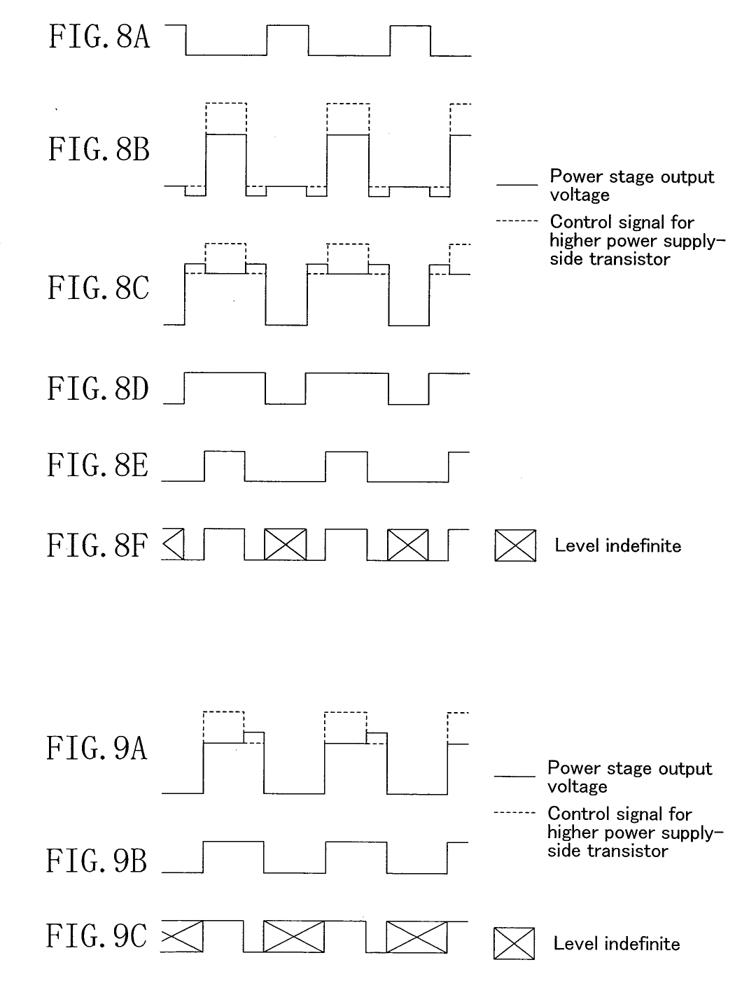

FIGS. 8A to 8F show the relationship between the control signal for the higher power supply-side transistor and the lower power supply-side transistor where there is a clamp circuit and the output voltage of the power stage 19. FIG. 8A is a timing diagram of the control signal for the lower power supply-side transistor. FIGS. 8B and 8C are timing diagrams of the control signal for the higher power supply-side transistor and the output voltage of the power stage 19 in the absence of the reverse flow of a phase current and those in the presence of the reverse flow of a phase current. In the absence of the reverse flow of a phase current, it is possible to correctly determine the ON state of the higher power supply-side transistor as shown in the timing diagram of FIG. 8E based on the control signal for the higher power supply-side transistor. In the presence of the reverse flow of a phase current, it is not possible to correctly determine the ON state of the transistor based only on the control signal for the higher power supply-side transistor (see the timing diagram of FIG. 8D).

In view of this, the control signal for the higher power supply-side transistor and the output voltage of the power stage 19 are compared with each other. The comparison result will be as shown in the timing diagram of FIG. 8F. When only the lower power supply-side transistor is ON, the L level of the control signal for the higher power supply-side transistor and that of the output voltage of the power stage 19 are independent of each other, whereby a comparison therebetween during such a period yields no meaningful result, hence the label “level indefinite”. By calculating the logical product between the comparison result and the control signal for the higher power supply-side transistor, it is possible to correctly determine the ON state of the higher power supply-side transistor as shown in the timing diagram of FIG. 8E even in the presence of the reverse flow of a phase current.

Even when the relationship between the control signal for the higher power supply-side transistor and the output voltage of the power stage 19 is as shown in the timing diagram of FIG. 9A, the comparison between the control signal for the higher power supply-side transistor and the output voltage of the power stage 19 is meaningful. Specifically, the comparison result is as shown in the timing diagram of FIG. 9B, and it is possible to correctly determine the ON state of the higher power supply-side transistor as shown in the timing diagram of FIG. 9C by calculating the logical product between the comparison result and the control signal for the higher power supply-side transistor.

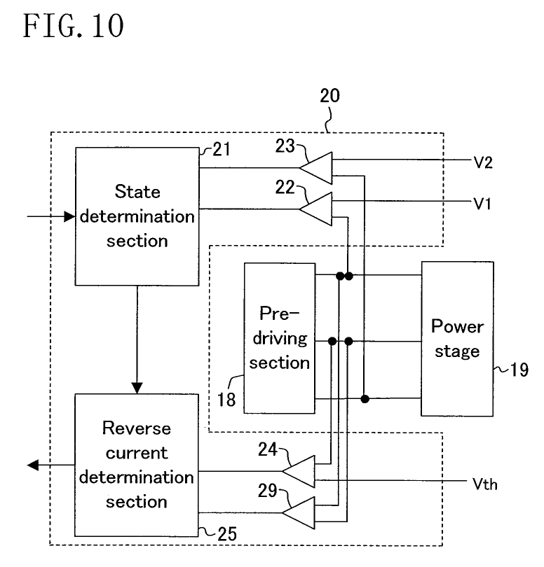

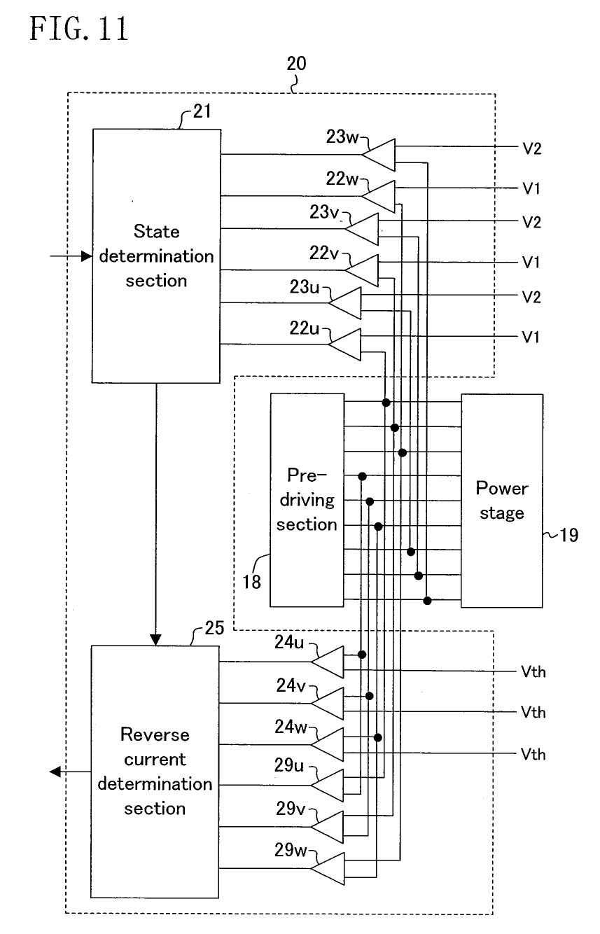

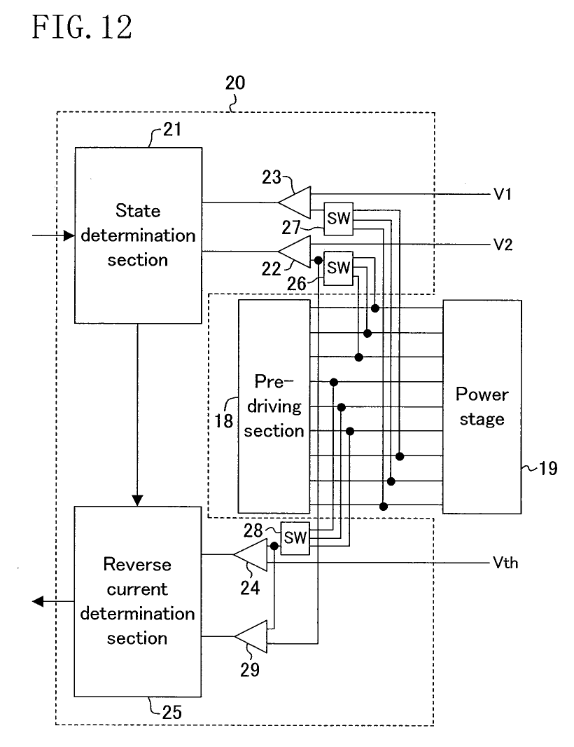

FIG. 10 shows a configuration of the reverse current detection apparatus 20 and a peripheral circuit thereof where there is a clamp circuit. The reverse current detection apparatus 20 is obtained by adding, to the reverse current detection apparatus 20 shown in FIG. 5, a comparator 29 for comparing the control signal for the higher power supply-side transistor with the output voltage of the power stage 19. FIG. 11 shows a configuration of the reverse current detection apparatus 20 for monitoring all phases of the motor 100 and a peripheral circuit thereof where there is a clamp circuit. The reverse current detection apparatus 20 is obtained by adding, to the reverse current detection apparatus 20 shown in FIG. 6, comparators 29u, 29v and 29w for comparing the control signal for the higher power supply-side transistor with the output voltage of the power stage 19. FIG. 12 shows a configuration of a reverse current detection apparatus with a reduced number of slicers and comparators and a peripheral circuit thereof where there is a clamp circuit. The reverse current detection apparatus 20 is obtained by adding, to the reverse current detection apparatus 20 shown in FIG. 7, the comparator 29 for comparing the control signal for the higher power supply-side transistor with the output voltage of the power stage 19.

Referring back to FIG. 1, upon receiving the reverse current detection signal, the rectification switching section 30 instructs the profile generating section 15 and the electrical conduction control section 17 to switch from synchronous rectification to non-synchronous rectification. When instructed by the rectification switching section 30 to switch to non-synchronous rectification, the profile generating section 15 generates a voltage profile such that a phase current with a limited conduction angle flows through the motor 100 and the electrical conduction control section 17 drives the pre-driving section 18 under non-synchronous rectification so as to prevent the power supply voltage from being increased by the reverse flow of a phase current.

Regeneration of a phase current is not always avoided by switching to non-synchronous rectification. Where the lower power supply-side transistor is driven in a chopped manner during the non-synchronous rectification period, the phase will be in the sink current mode, and when the lower power supply-side transistor is turned OFF, the sink current recirculates to the higher power supply. If the on-duty of the higher power supply-side transistor of another phase is insufficient, there is a regeneration effect to thereby increase the power supply voltage. Moreover, the regeneration effect is increased depending on the difference between the phase of the phase current and the phase of the back-electromotive force. In other words, if the period in which the lower power supply-side transistor is driven in a chopped manner is 180 electrical degrees, there will be a regeneration of a phase current even with a slight phase difference between the phase current and the back-electromotive force. In order to avoid this, the period in which the lower power supply-side transistor is driven in a chopped manner needs to be made sufficiently shorter than 180 electrical degrees within such a range that there is a phase difference. For example, the period may be shortened to 120 electrical degrees or less. Moreover, it is preferred that the lower power supply-side transistor is left continuously ON, instead of being driven in a chopped manner.

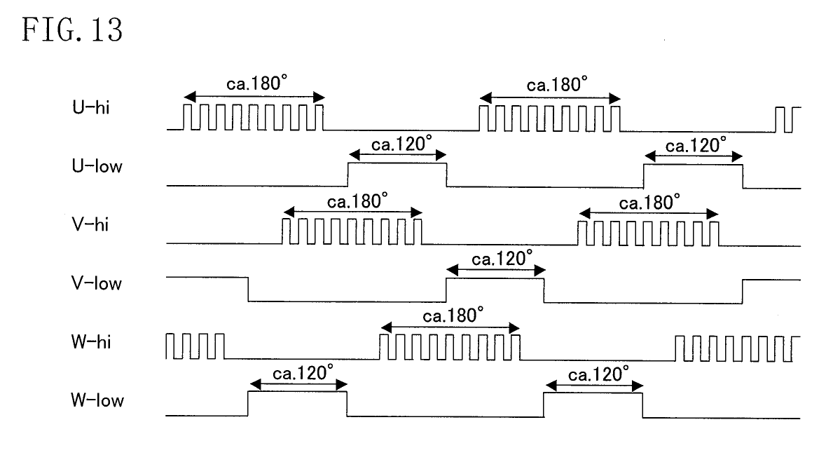

FIG. 13 shows an example of how to control the higher power supply-side transistor and the lower power supply-side transistor of each of the U phase, the V phase and the W phase under non-synchronous rectification. For example, the higher power supply-side transistor (hi) of each phase is driven under PWM over a period of about 180 electrical degrees while the lower power supply-side transistor (low) of each phase is left continuously ON, instead of being driven in a chopped manner, over a period of about 120 electrical degrees, as shown in the figure. With such a control, however, the distortion of the current waveform increases, and the low vibration characteristics and the low noise characteristics of the motor 100 deteriorate. Therefore, a control as described above should be used only when it is desired to reliably avoid the phase current regeneration.

After the passage of a predetermined amount of time since the instruction to switch to non-synchronous rectification, the rectification switching section 30 instructs the profile generating section 15 and the electrical conduction control section 17 to switch from non-synchronous rectification to synchronous rectification. When it is instructed by the rectification switching section 30 to switch to synchronous rectification, the profile generating section 15 generates a voltage profile such that a sinusoidal phase current flows through the motor 100 and the electrical conduction control section 17 drives the pre-driving section 18 under synchronous rectification so as to drive the motor 100 with low noise and low vibration.

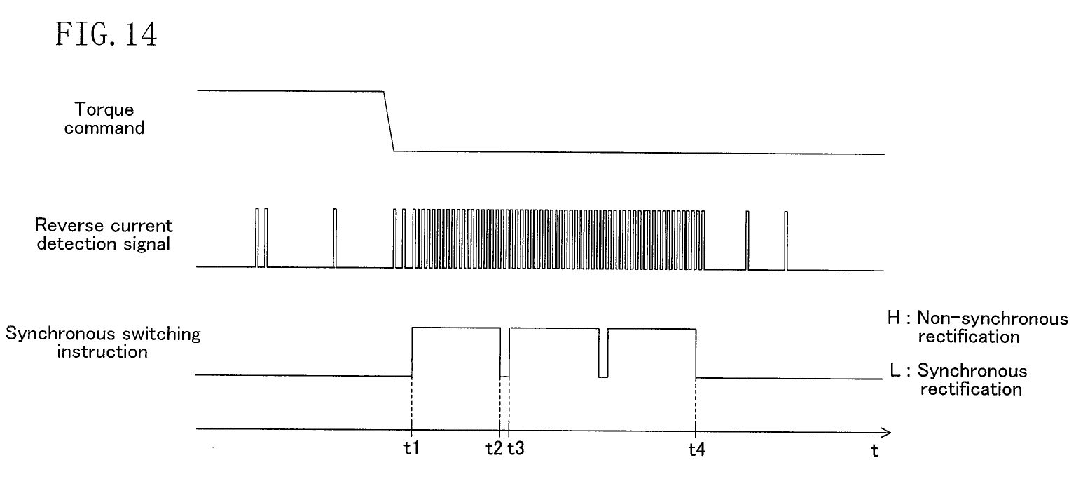

FIG. 14 shows an example of how rectification schemes are switched from one to another by the rectification switching section 30. If the reverse flow of a phase current occurs due to a rapid decrease of the torque command, the reverse current detection signal is asserted at short intervals. Then, the rectification scheme is switched from synchronous rectification to non-synchronous rectification at time t1 when the frequency with which the reverse flow of a phase current is detected exceeds a predetermined value. For example, the rectification scheme may be switched to non-synchronous rectification when the reverse current detection signal is asserted a plurality of times within a period of 60 electrical degrees. Then, the rectification scheme is switched back to synchronous rectification at time t2, i.e., after the passage of a predetermined amount of time since the switching to non-synchronous rectification. For example, the predetermined amount of time is an amount of time that accounts for a predetermined number of repetitions of 60 electrical degrees. The predetermined number of repetitions may be changed appropriately depending on the motor system being used. If the reverse current detection signal is still asserted at short intervals after the rectification scheme is switched to synchronous rectification at time t2, the rectification scheme is switched again to non-synchronous rectification at time t3 when the frequency with which the reverse flow of a phase current is detected exceeds the predetermined value. As the rectification schemes are switched around a number of times, the reverse flow of a phase current will be resolved. After time t4, the motor 100 is driven under a synchronous rectification scheme with low vibration characteristics and low noise characteristics. Although the reverse current detection signal is asserted before time t1 and after time t4, the switching of the rectification scheme is not triggered by such sporadic assertions, which are likely to be erroneous detections or noise.

As described above, according to the present embodiment, the motor is normally driven by a sinusoidal current under synchronous rectification, but the rectification scheme can be switched to non-synchronous rectification with a small conduction angle when the reverse flow of a phase current occurs and the higher power supply potential is about to increase. Thus, it is possible to suppress the regeneration of a phase current while maintaining the low vibration characteristics and the low noise characteristics of the motor.

The error amplification section 11 may be omitted, and the torque command TQ may be input directly to the profile generating section 15. A sensor-less position detection section for detecting the rotor position based on the back-electromotive force through the motor coil may be provided, instead of the rotor position sensor 14. The duty cycle generating section 16 may generate a PWM signal by comparing the command signal for each phase with a triangular wave or by performing a logic operation based on the command signal for each phase.

The reverse flow of a phase current may be detected, whereby the rectification scheme is switched to non-synchronous rectification, based on the voltage of the shunt resistor 12 becoming negative. In such a case, in order to avoid an erroneous detection, it is preferred that whether the voltage of the shunt resistor 12 is negative is determined at a point in time that is not the timing of transition of PWM switching.

The system safety level can be enhanced by adding, to the motor driving apparatus of the present embodiment, a function of bringing the power supply potential back to an appropriate value by stopping the reverse flow of a phase current through short-circuit braking over a predetermined period of time when the higher power supply voltage becomes greater than or equal to a predetermined voltage.

What is claimed is:

1. A method for detecting a reverse flow of a phase current supplied to a motor coil from a node between a higher power supply-side transistor and a lower power supply-side transistor, which are connected in series with each other to form a half bridge, by driving the half bridge under a PWM control, the method comprising the steps of:
determining whether an electrical conduction control to the motor coil is in a predetermined state based on a timing signal representing a timing at which to conduct a source current or a sink current through the motor coil and a control signal for the half bridge;
comparing a voltage at the node with a threshold value;
determining whether the voltage at the node is shifted from an ideal value in the predetermined state based on a result of the comparison; and
determining that the phase current is reversed if it is determined that the electrical conduction control to the motor coil is in the predetermined state and if it is determined that the voltage at the node is shifted from the ideal value.

2. The reverse current detection method of claim 1, wherein
the predetermined state is a state where it is instructed to conduct a source current or a sink current through the motor coil and it is instructed to turn OFF the higher power supply-side transistor and the lower power supply-side transistor; and
the threshold value is greater than a potential that is lower than that of the lower power supply by a forward voltage drop of a free wheeling diode connected in parallel to the lower power supply-side transistor, and the threshold value is lower than a potential that is higher than that of the higher power supply by a forward voltage drop of a free wheeling diode connected in parallel to the higher power supply-side transistor.

3. The reverse current detection method of claim 1, wherein
the predetermined state is a state where it is instructed to conduct a source current or a sink current through the motor coil and it is instructed to turn ON the higher power supply-side transistor; and
the threshold value is within a predetermined range that is centered about a potential of the higher power supply.

4. The reverse current detection method of claim 1, wherein
the predetermined state is a state where it is instructed to conduct a source current or a sink current through the motor coil and it is instructed to turn ON the lower power supply-side transistor; and
the threshold value is within a predetermined range that is centered about a potential of the lower power supply.

5. A motor driving method for driving a motor under a PWM control, comprising:
a first step of detecting a reverse flow of a phase current supplied to at least one motor coil of the motor according to the reverse current detection method of claim 1; and
a second step of switching a rectification scheme of the PWM control of the motor from synchronous rectification to non-synchronous rectification when the reverse flow of a phase current is detected.

6. The motor driving method of claim 5, wherein in the second step, the rectification scheme of the PWM control of the motor is switched when a frequency with which the reverse flow of a phase current is detected exceeds a predetermined value.

7. The motor driving method of claim 5, further comprising a third step of switching the rectification scheme of the PWM control of the motor back to synchronous rectification after passage of a predetermined amount of time since the switching of the rectification scheme of the PWM control of the motor to non-synchronous rectification.

8. The motor driving method of claim 5, wherein when it is instructed to conduct a sink current through the motor coil where the motor is driven under a PWM control with non-synchronous rectification, a lower power supply-side transistor in a half bridge for supplying a current to the motor coil is left continuously ON for a predetermined amount of time instead of driving the lower power supply-side transistor in a chopped manner.

9. The motor driving method of claim 5, wherein where the motor is driven under a PWM control with non-synchronous rectification, a direction of electrical conduction through the motor coil is switched from one to another while securing a period during which a higher power supply-side transistor and a lower power supply-side transistor of a half bridge for supplying a current to the motor coil are both OFF.

10. An apparatus for detecting a reverse flow of a phase current supplied to a motor coil from a node between a higher power supply-side transistor and a lower power supply-side transistor, which are connected in series with each other to form a half bridge, by driving the half bridge under a PWM control, the apparatus comprising:
a state determination section for receiving a timing signal representing a timing at which to conduct a source current or a sink current through the motor coil and a control signal for the half bridge, and for determining whether an electrical conduction control to the motor coil is in a predetermined state based on the received signals;
a comparator for comparing a voltage at the node with a threshold value; and
a reverse current determination section for determining whether the phase current is reversed based on a determination result of the state determination section and a comparison result of the comparator.

11. The reverse current detection apparatus of claim 10, further comprising:
a slicer for digitizing a control signal for the higher power supply-side transistor; and
a slicer for digitizing a control signal for the lower power supply-side transistor;
the state determination section receives outputs from the two slicers as the control signal for the half bridge;
the predetermined state is a state where it is instructed to conduct a source current or a sink current through the motor coil and it is instructed to turn OFF the higher power supply-side transistor and the lower power supply-side transistor; and
the threshold value is greater than a potential that is lower than that of the lower power supply by a forward voltage drop of a free wheeling diode connected in parallel to the lower power supply-side transistor, and the threshold value is lower than a potential that is higher than that of the higher power supply by a forward voltage drop of a free wheeling diode connected in parallel to the higher power supply-side transistor.

12. The reverse current detection apparatus of claim 11, further comprising:
a second comparator for comparing the control signal for the higher power supply-side transistor with the voltage at the node,
wherein the state determination section receives a comparison result of the second comparator to calculate a logical product between an output of the slicer for digitizing the control signal for the higher power supply-side transistor and the comparison result of the second comparator, and uses the calculated logical product as the control signal for the higher power supply-side transistor.

13. The reverse current detection apparatus of claim 10, further comprising:
a slicer for digitizing a control signal for the higher power supply-side transistor, wherein
the state determination section receives an output of the slicer as the control signal for the half bridge;
the predetermined state is a state where it is instructed to conduct a source current or a sink current through the motor coil and it is instructed to turn ON the higher power supply-side transistor; and
the threshold value is within a predetermined range that is centered about a potential of the higher power supply.

14. The reverse current detection apparatus of claim 13, further comprising:
a second comparator for comparing the control signal for the higher power supply-side transistor with the voltage at the node,
wherein the state determination section receives a comparison result of the second comparator to calculate a logical product between an output of the slicer for digitizing the control signal for the higher power supply-side transistor and the comparison result of the second comparator, and uses the calculated logical product as the control signal for the higher power supply-side transistor.

15. The reverse current detection apparatus of claim 10, further comprising:
a slicer for digitizing a control signal for the lower power supply-side transistor, wherein
the state determination section receives an output of the slicer as the control signal for the half bridge;
the predetermined state is a state where it is instructed to conduct a source current or a sink current through the motor coil and it is instructed to turn ON the lower power supply-side transistor; and
the threshold value is within a predetermined range that is centered about a potential of the lower power supply.

16. The reverse current detection apparatus of claim 10, further comprising a switch for selecting, for each repetition of a predetermined electrical angle, the voltage at the node and the control signal for the half bridge for one of a plurality of phases.

17. A motor driving apparatus for driving a motor under a PWM control, comprising:
the reverse current detection apparatus of claim 10; and
a rectification switching section for switching between synchronous rectification and non-synchronous rectification as a rectification scheme of the motor driving apparatus based on a detection result of the reverse current detection apparatus.

18. The motor driving apparatus of claim 17, wherein the rectification switching section switches the rectification scheme of the PWM control of the motor from synchronous rectification to non-synchronous rectification when a frequency with which the reverse flow of a phase current is detected by the reverse current detection apparatus exceeds a predetermined value.

19. The motor driving apparatus of claim 17, wherein the rectification switching section switches the rectification scheme of the PWM control of the motor back to synchronous rectification after passage of a predetermined amount of time since the switching of the rectification scheme of the PWM control of the motor to non-synchronous rectification.

20. The motor driving apparatus of claim 17, wherein when it is instructed to conduct a sink current through the motor coil where the motor is driven under a PWM control with non-synchronous rectification, a lower power supply-side transistor in a half bridge for supplying a current to the motor coil is left continuously ON for a predetermined amount of time instead of driving the lower power supply-side transistor in a chopped manner.

21. The motor driving apparatus of claim 17, wherein where the motor is driven under a PWM control with non-synchronous rectification, a direction of electrical conduction through the motor coil is switched from one to another while securing a period during which a higher power supply-side transistor and a lower power supply-side transistor of a half bridge for supplying a current to the motor coil are both OFF.
